(19) United States
(12) Patent Application Publication
(10) Pub. No.: US 2026/0030322 A1
(43) Pub. Date: Jan. 29, 2026

(54) TRACING SOURCES OF GENERATIVE ARTIFICIAL INTELLIGENCE MACHINE LEARNING MODEL OUTPUT

(71) Applicant: Amazon Technologies, Inc., Seattle, WA (US)

(72) Inventors: Dexter MARKLEY, Oakhurst, CA (US); David Alan HAWKINS, Camas, WA (US); Eric Jason BRANDWINE, Haymarket, VA (US)

(21) Appl. No.: 18/781,732

(22) Filed: Jul. 23, 2024

(51) Int. Cl. G06F 18/214; G06F 18/22; G06N 3/0475

(52) U.S. Cl. CPC G06F 18/214; G06F 18/22; G06N 3/0475

(57) ABSTRACT

Techniques for tracing a source for a generative artificial intelligence model output are described. In some examples, a source is traced by generating content using the GenAI model; generating a fingerprint for the content; comparing the fingerprint for the content to one or more fingerprints for content of one or more datasets to determine a match; retrieving metadata associated with the match; and determining and performing one or more actions in response to the retrieved metadata.

### BACKGROUND

Generative artificial intelligence (GenAI) machine learning models are capable of predicting text, images, sound, etc. Large GenAI models are typically trained using very large datasets. These datasets may include publicly available code that may come from open-source repositories and/or, in the case of non-public GenAI models, may come from private repositories (e.g., repositories for a particular company).

### BRIEF DESCRIPTION OF DRAWINGS

Various examples in accordance with the present disclosure will be described with reference to the drawings, in which:

FIG. 1 illustrates examples of systems that support the tracing of a source of GenAI output.

FIG. 2 illustrates examples of usage of a source tracing service.

FIG. 3 illustrates examples of fingerprints for fingerprinted content and metadata for fingerprinted content being stored as elements of a data structure.

FIG. 4 illustrates examples of usage of a source tracing service.

FIG. 5 illustrates examples of usage of a source tracing service.

FIG. 6 illustrates examples of usage of a source tracing in a client device.

FIG. 7 is a flow diagram illustrating operations of a method for at least source tracing for GenAI output according to some examples.

FIG. 8 is a flow diagram illustrating operations of a method for building a collection of fingerprints and associated metadata according to some examples.

FIG. 9 is a flow diagram illustrating operations of a method for at least source tracing for a file according to some examples.

FIG. 10 is a flow diagram illustrating operations of a method for at least source tracing for a file according to some examples.

FIG. 11 illustrates an example cloud provider network environment according to some examples.

FIG. 12 is a block diagram of an example cloud provider network that provides a storage service and a hardware virtualization service to customers according to some examples.

FIG. 13 is a block diagram illustrating an example computing device that can be used in some examples.

### DETAILED DESCRIPTION

The present disclosure relates to methods, apparatus, systems, and non-transitory computer-readable storage media for at least tracing sources of GenAI model output.

As noted, GenAI systems are capable of producing text, images, code, music, video, etc. after being trained or fine-tuned on datasets. Some of these datasets are subject to open-source licenses. For example, some code used to train a GenAI model may be subject to one or more open-source licenses. Being able to properly attribute code generated by GenAI tools to open-source, third party, and/or proprietary repositories where applicable and apply licensing information and/or know where GenAI produced code has been committed in code repositories for entities are important, but currently infeasible, tasks.

Detailed herein are examples of a cloud provider network source tracing service which may be used to discover a source of a GenAI output and/or maintain information about where output of a GenAI is used. In some examples, when training a GenAI model that will be capable of producing output, the source material used for training the GenAI tool is hashed (e.g., with a minhash fingerprint) and classified by the source tracing service.

When output (e.g., code) is produced for a user, the source tracing hashes, stores, and classifies the output before it is sent to the user. If any licensing information should be attached with the output, the user will be notified.

In some examples, users of the tracing service may request GenAI produced output for use in example production systems. Users can request code, etc. from a repository and the tracing service will provide information on where that code, etc. comes from and if it is encumbered by any licensing issues, etc.

In some examples, aspects of the source training service are incorporated in clients. For example, a client running on a device external to the cloud provider network.

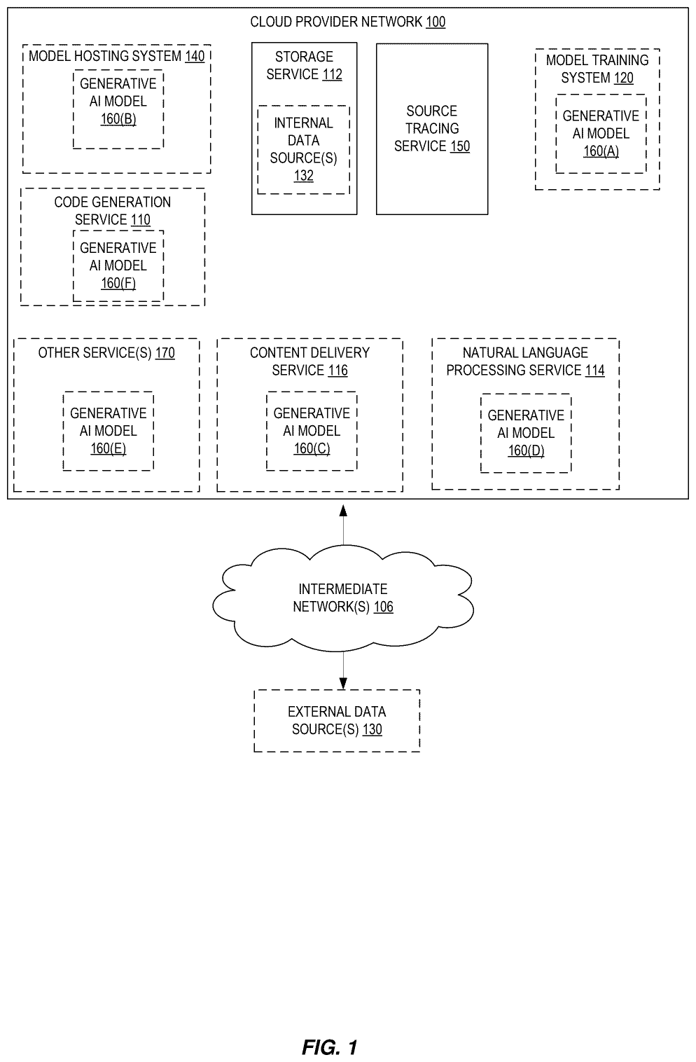

FIG. 1 illustrates examples of systems that support the tracing of a source of GenAI output. In this illustration, a cloud provider network 100 includes a source tracing service 150. This source tracing service 150 supports one or more of: tracing output produced by a GenAI model (e.g., GenAI model(s) 160(A)-(E)) produced output, providing metadata about GenAI model produced output, and/or performing one or more actions regarding GenAI produced output. In particular, the GenAI model(s) may produce output based on training data (note training data may refer to data used to train an algorithm, fine-tune a model, etc.) or retrieved augmented data from internal data source(s) 132 (e.g., stored by a storage service 112) and/or external data source(s) 130 (e.g., public repositories of code, text, images, audio, video, etc.). Details of examples of how the source training service 150 operates are provided below.

The cloud provider network 100 may include one or more other services. In some examples, the cloud provider network 100 includes a model training system 120 service. This service allows a user to train models, fine-tune models, etc. including GenAI models such as GenAI model 120(A).

A model hosting system 140 service allows for a model (such as GenAI model 160(B)) to be hosted on the cloud provider network 100. In some examples, the model hosting service provides a code generation service 110 which may utilize the GenAI model 160(F) to generate code. Note that the code generation service 110 is a part of the model hosting system 140 and/or model training system 120 in some examples. Generated code may be hosted by the cloud provider network 100 or be a part of code for one or more of the services of the cloud provider network 100.

In some examples, a content delivery service 116 is provided by the cloud provider network 100. A content delivery service 116 may use a GenAI model 160(C) to generate content (e.g., video, audio, etc.).

In some examples, a natural language processing (NLP) service 114 is provided by the cloud provider network 100. The NLP service 116 may use a GenAI model 160(D) to generate text from speech, provide virtual assistants, provide multi-lingual content, etc.

One or more other service(s) 170 may also use a GenAI model 160(E) to produce content.

The source training service 150 may be used to trace, etc. output of each of these services in some examples.

The cloud provider network 100 (also referred to herein as a provider network, service provider network, etc.) provides users with the ability to use one or more of a variety of types of computing-related resources such as compute resources (e.g., executing virtual machine (VM) instances and/or containers, executing batch jobs, executing code without provisioning servers), data/storage resources (e.g., object storage, block-level storage, data archival storage, databases and database tables, etc.), network-related resources (e.g., configuring virtual networks including groups of compute resources, content delivery networks (CDNs), Domain Name Service (DNS)), application resources (e.g., databases, application build/deployment services), access policies or roles, identity policies or roles, machine images, routers and other data processing resources, etc. These and other computing resources can be provided as services, such as a hardware virtualization service that can execute compute instances, a storage service that can store data objects, etc. The users (or “customers”) of cloud provider networks 100 can use one or more user accounts that are associated with a customer account, though these terms can be used somewhat interchangeably depending upon the context of use. Cloud provider networks are sometimes “multi-tenant” as they can provide services to multiple different customers using the same physical computing infrastructure; for example, virtual machine instances may be concurrently hosted for different customers using a same underlying physical host computing device.

Users can interact with a cloud provider network 100 across one or more intermediate networks 106 (e.g., the internet) via one or more interface(s), such as through use of application programming interface (API) calls, via a console implemented as a website or application, etc. An API refers to an interface and/or communication protocol between a client and a server, such that if the client makes a request in a predefined format, the client should receive a response in a specific format or initiate a defined action. In the cloud provider network context, APIs provide a gateway for customers to access cloud infrastructure by allowing customers to obtain data from or cause actions within the cloud provider network, enabling the development of applications that interact with resources and services hosted in the cloud provider network. APIs can also enable different services of the cloud provider network to exchange data with one another. The interface(s) can be part of, or serve as a front-end to, a control plane of the cloud provider network 100 that includes “backend” services supporting and enabling the services that can be more directly offered to customers.

Thus, a cloud provider network (or just “cloud”) typically refers to a large pool of accessible virtualized computing resources (such as compute, storage, and networking resources, applications, and services). A cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

A cloud provider network can be formed as a number of regions, where a region is a geographical area in which the cloud provider clusters data centers. Each region includes multiple (e.g., two or more) availability zones (AZs) connected to one another via a private high-speed network, for example a fiber communication connection. An AZ (also known as a “zone”) provides an isolated failure domain including one or more data center facilities with separate power, separate networking, and separate cooling from those in another AZ. A data center refers to a physical building or enclosure that houses and provides power and cooling to servers of the cloud provider network. Preferably, AZs within a region are positioned far enough away from one another so that a natural disaster (or other failure-inducing event) should not affect or take more than one AZ offline at the same time.

Users can connect to an AZ of the cloud provider network via a publicly accessible network (e.g., the Internet, a cellular communication network), e.g., by way of a transit center (TC). TCs are the primary backbone locations linking users to the cloud provider network and can be collocated at other network provider facilities (e.g., Internet service providers (ISPs), telecommunications providers) and securely connected (e.g., via a VPN or direct connection) to the AZs. Each region can operate two or more TCs for redundancy. Regions are connected to a global network which includes private networking infrastructure (e.g., fiber connections controlled by the cloud provider) connecting each region to at least one other region. The cloud provider network can deliver content from points of presence (or “POPs”) outside of, but networked with, these regions by way of edge locations and regional edge cache servers. This compartmentalization and geographic distribution of computing hardware enables the cloud provider network to provide low-latency resource access to users on a global scale with a high degree of fault tolerance and stability.

To provide these and other computing resource services, cloud provider networks 100 often rely upon virtualization techniques. For example, virtualization technologies can provide users the ability to control or use compute resources (e.g., a “compute instance,” such as a VM using a guest operating system (O/S) that operates using a hypervisor that might or might not further operate on top of an underlying host O/S, a container that might or might not operate in a VM, a compute instance that can execute on “bare metal” hardware without an underlying hypervisor), where one or multiple compute resources can be implemented using a single electronic device. Thus, a user can directly use a compute resource (e.g., provided by a hardware virtualization service) hosted by the provider network to perform a variety of computing tasks. Additionally, or alternatively, a user can indirectly use a compute resource by submitting code to be executed by the provider network (e.g., via an on-demand code execution service), which in turn uses one or more compute resources to execute the code-typically without the user having any control of or knowledge of the underlying compute instance(s) involved.

As described herein, one type of service that a provider network may provide may be referred to as a “managed compute service” that executes code or provides computing resources for its users in a managed configuration. Examples of managed compute services include, for example, an on-demand code execution service, a hardware virtualization service, a container service, or the like.

An on-demand code execution service (referred to in various examples as a function compute service, functions service, cloud functions service, functions as a service, or serverless computing service) can enable users of the cloud provider network 100 to execute their code on cloud resources without having to select or manage the underlying hardware resources used to execute the code. For example, a user can use an on-demand code execution service by uploading their code and use one or more APIs to request that the service identify, provision, and manage any resources required to run the code. Thus, in various examples, a “serverless” function can include code provided by a user or other entity—such as the provider network itself—that can be executed on demand. Serverless functions can be maintained within the provider network by an on-demand code execution service and can be associated with a particular user or account or can be generally accessible to multiple users/accounts. A serverless function can be associated with a Uniform Resource Locator (URL), Uniform Resource Identifier (URI), or other reference, which can be used to invoke the serverless function. A serverless function can be executed by a compute resource, such as a virtual machine, container, etc., when triggered or invoked. In some examples, a serverless function can be invoked through an application programming interface (API) call or a specially formatted HyperText Transport Protocol (HTTP) request message. Accordingly, users can define serverless functions that can be executed on demand, without requiring the user to maintain dedicated infrastructure to execute the serverless function. Instead, the serverless functions can be executed on demand using resources maintained by the cloud provider network 100. In some examples, these resources can be maintained in a “ready” state (e.g., having a pre-initialized runtime environment configured to execute the serverless functions), allowing the serverless functions to be executed in near real-time.

Another type of managed compute service can be a container service, such as a container orchestration and management service (referred to in various implementations as a container service, cloud container service, container engine, or container cloud service) that allows users of the cloud provider network to instantiate and manage containers. In some examples the container service can be a Kubernetes-based container orchestration and management service (referred to in various implementations as a container service for Kubernetes, Azure Kubernetes service, IBM cloud Kubernetes service, Kubernetes engine, or container engine for Kubernetes). A container, as referred to herein, packages up code and all its dependencies so an application (also referred to as a task, pod, or cluster in various container services) can run quickly and reliably from one computing environment to another. A container image is a standalone, executable package of software that includes everything needed to run an application process: code, runtime, system tools, system libraries and settings. Container images become containers at runtime. Containers are thus an abstraction of the application layer (meaning that each container simulates a different software application process). Though each container runs isolated processes, multiple containers can share a common operating system, for example by being launched within the same virtual machine. In contrast, virtual machines are an abstraction of the hardware layer (meaning that each virtual machine simulates a physical machine that can run software). While multiple virtual machines can run on one physical machine, each virtual machine typically has its own copy of an operating system, as well as the applications and their related files, libraries, and dependencies. Some containers can be run on instances that are running a container agent, and some containers can be run on bare-metal servers, or on an offload card of a server.

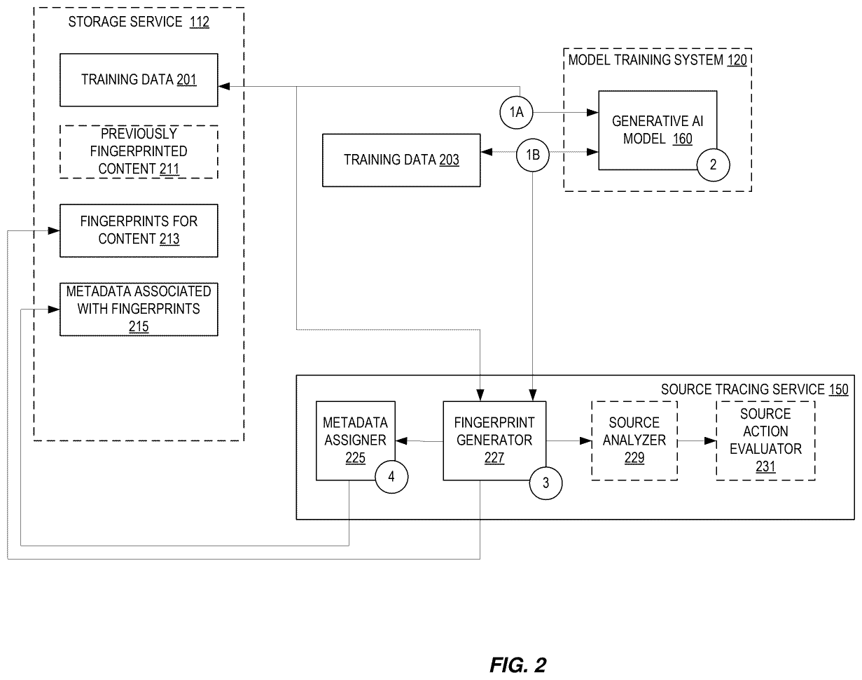

FIG. 2 illustrates examples of usage of a source tracing service. In this illustration, the source tracing service 150 is used during the training of a generative AI model 160 to generate fingerprints for the content (e.g., files, images, text, audio, and/or portions thereof, etc.) of the training data which may be internal to the cloud provider network 100 such as being stored by a storage service 112 thereof (shown as training data 201) and/or external to the cloud provider network 100 (shown as training data 203).

As training data is fed into the model training system 120 to train (or fine-tune) the model 160 (shown as circles 1A and 1B) for training at circle 2, that training data is also sent to the source tracing service 150. Note that in some examples, the source tracing service 150 is incorporated into another service (such as the model training system 120).

A fingerprint generator 227 generates fingerprints for the training data at circle 3. In some examples, the fingerprint generator 227 for each content, the fingerprint generator 227 performs a word tokenization of the content (e.g., removes stop words, performs lemmatization, stems words, and/or drops words less than a particular number of characters (such as 5 characters), then hashes the tokens (e.g., using overlapping, sliding windows) to generate a set of values (e.g., integers), the set of integers are then minimized by applying a hash function (e.g., minhash) to generate a signature.

Each content is also as metadata using metadata assigner 225 at circle 4. The metadata assigner 225 may include a classifier (e.g., using a multi-class classification model, etc.) to assign a class to the content. The metadata assigner 225 may also add a link to the content, an indication of what license the contentis under (e.g., which open-source license applies and that may be determined from the repository or the contentitself), known usage of the content, etc.

The metadata and a fingerprint are stored (e.g., using storage service 112) for later use. In this example, the fingerprints for fingerprinted content 213 and metadata associated with fingerprinted content 215 are shown as being stored separately. However, fingerprints and metadata may be stored together. In some examples, fingerprints and metadata are stored in ways to minimize searching against them. For example, fingerprints for a particular class or license are stored together, etc.

In some examples, previously fingerprinted content 211 are also stored. This is not as likely for large sets of training data that are readily available in accessible locations.

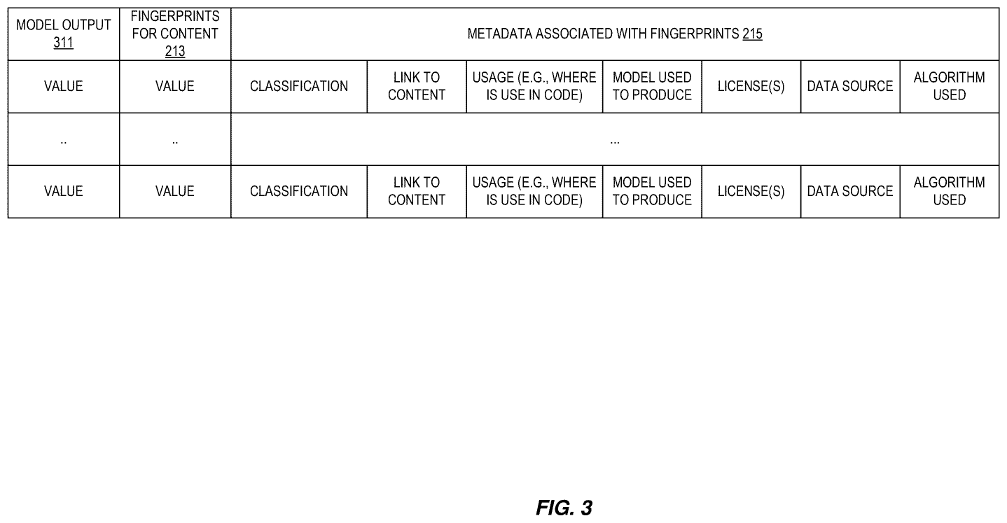

FIG. 3 illustrates examples of fingerprints for fingerprinted content and metadata for fingerprinted content being stored as elements of a data structure. As shown, each fingerprint for fingerprinted content 213 has a value and metadata associated with fingerprinted content 215 is associated with that fingerprint. The metadata 215 may be stored in separate columns or rows for easier manipulation. Examples of metadata 215 that may be stored include a classification for a content (e.g., the content is “secret,” the contentis of a certain type, etc.), a link to the content, a usage for the content (e.g., if the contentis code that has been committed, where that code is committed), an indication of a model used to produce the content, an indication of one or more license(s) for the content, a data source that the contentbelongs to, an indication of the algorithm(s) used to fingerprint, etc.

In some examples, a model output 311 identifier is also saved. There could be multiple fingerprints, content, etc.

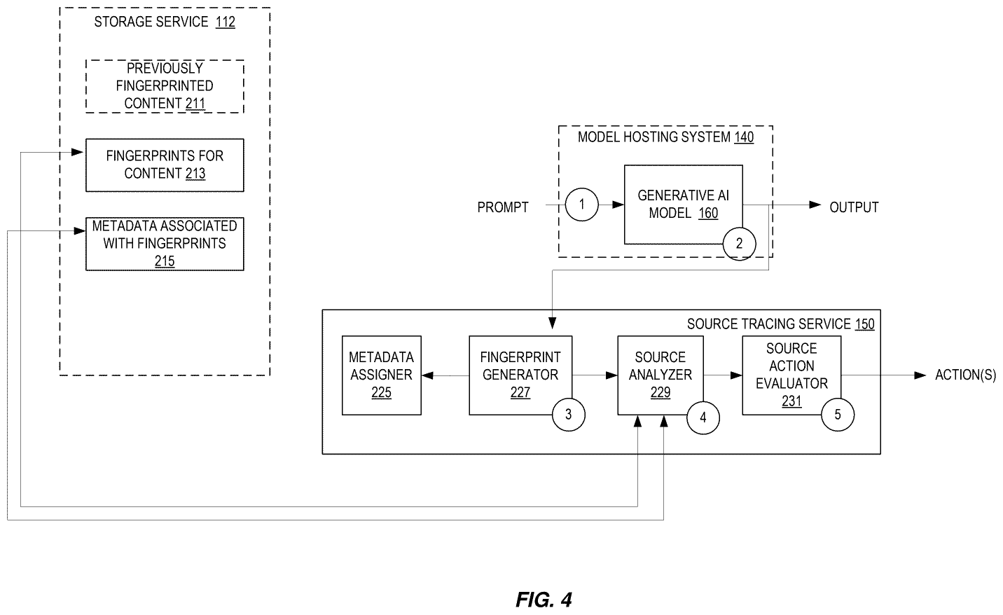

FIG. 4 illustrates examples of usage of a source tracing service. In this illustration, the GenAI model 160 receives a prompt at circle 1 and generates output at circle 2. The output may be an image, code, text, etc. The output is then sent to the source tracing service 150 to generate a fingerprint for the output using fingerprint generator 227 at circle 3.

The fingerprint signature is passed to a source analyzer 229. The source analyzer 229 compares the generated fingerprint to one or more fingerprints for fingerprinted content 213 to determine if there are any fingerprint matches at circle 4. A match may indicate that a particular one or more of the fingerprinted content 213 was used by the GenAI model 160 to generate the output. Metadata with a match is retrieved by the source analyzer 229.

The retrieved metadata is used by the source action evaluator 231 to determine, at circle 5, what sort of action, if any, should be performed and/or proposed. For example, an action may be to block the output from being incorporated into a project (e.g., block code from being used). This block may be based, at least in part, on the license associated with the matching contentused during training. Other actions may include, but are not limited to: providing a notification of any license, updating an indication of usage (e.g., that the output is being used in a particular manner), filtering content from a response (e.g., data that was used for training to be filtered out—in some examples, data is filtered if it matches x % of some content), matching sensitive data (e.g., utterances, sections of content, etc.), utilizing a list of tokens to block (e.g., social security numbers, etc.), etc.

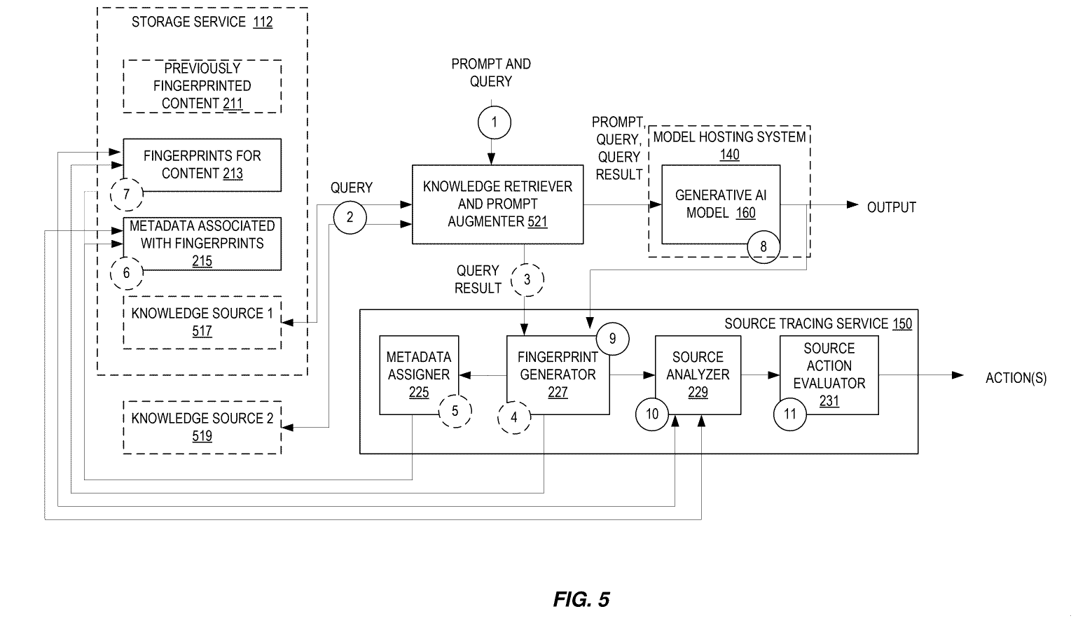

FIG. 5 illustrates examples of usage of a source tracing service. In this illustration, the GenAI model 160 utilizes retrieval augmented generation (RAG) techniques. A prompt and query are received by a knowledge retriever and prompt augmented 521 at circle 1. The query identifies one or more knowledge sources (e.g., an internal knowledge source 1 517 and/or an external knowledge source 2 519) which are accessed to retrieve one or more content at circle 2 as a query result.

In some examples, the query result is passed, at circle 3, to the fingerprint generator 227 to generate a fingerprint for the query at circle 4 and assign metadata at circle 5 using metadata assigner 225. The metadata and fingerprint are then stored at circles 6 and 7 respectively. This fingerprint, etc. generation allows for new fingerprints, etc. to be added during runtime which helps build up the dataset of fingerprints and metadata.

The prompt, query, and/or query result are passed to the GenAI model 160 which generates output at circle 8. The output may be an image, code, text, etc. The output is then sent to the source tracing service 150 to generate a fingerprint for the output using fingerprint generator 227 at circle 9.

The generated fingerprint is passed to a source analyzer 229. The source analyzer 229 compares the generated fingerprint to one or more fingerprints for fingerprinted content 213 to determine if there are any fingerprint matches at circle 10. A match may indicate that a particular one or more of the fingerprinted content 213 was used by the GenAI model 160 to generate the output. Metadata with a match is retrieved by the source analyzer 229.

The retrieved metadata is used by the source action evaluator 231 to determine, at circle 11, what sort of action, if any, should be performed and/or proposed. For example, an action may be blocking the output from being incorporated into a project (e.g., block code from being used). This block may be based, at least in part, on the license associated with the matching content used during training. Other actions may include, but are not limited to: providing a notification of any license, updating an indication of usage (e.g., that the output is being used in a particular manner), etc.

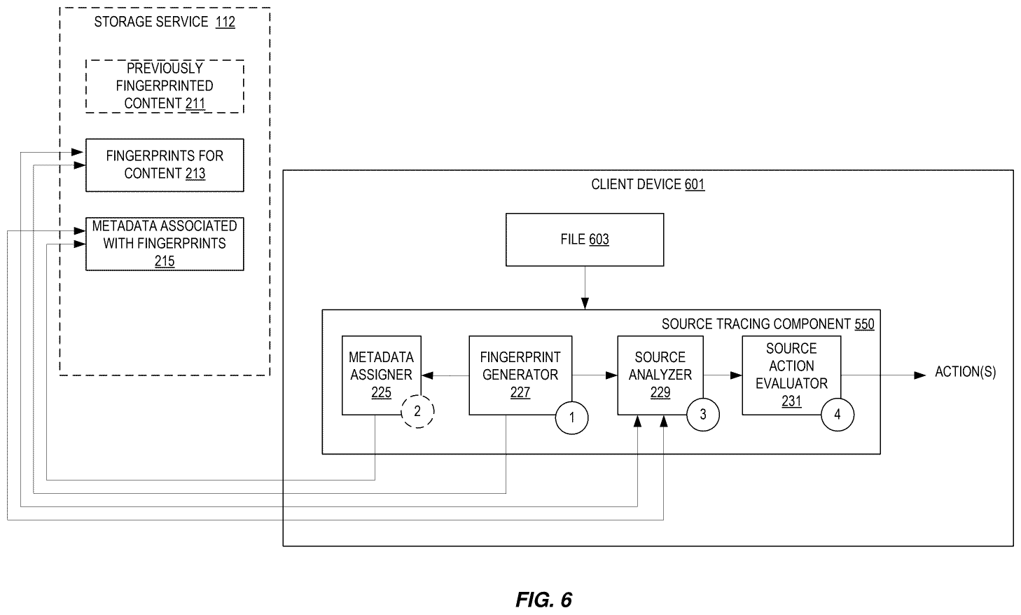

FIG. 6 illustrates examples of usage of a source tracing in a client device. In this illustration, a client device 601 has content 603 that is to be evaluated against existing fingerprints. The content 603 is passed, at circle 3, to the fingerprint generator 227 to generate a fingerprint for the query at circle 1 and, in some examples, assign metadata at circle 2 using metadata assigner 225. The metadata and fingerprint are then stored in some examples. This fingerprint, etc. generation allows for new fingerprints, etc. to be added during runtime which helps build up the dataset of fingerprints and metadata. Note that the content itself does not need to be saved.

The generated fingerprint is passed to a source analyzer 229. The source analyzer 229 compares the generated fingerprint to one or more fingerprints for fingerprinted content 213 to determine if there are any fingerprint matches at circle 3. A match may indicate that a particular one or more of the fingerprinted content 213 aligns with content 603. Metadata with a match is retrieved by the source analyzer 229.

The retrieved metadata is used by the source action evaluator 231 to determine, at circle 4, what sort of action, if any, should be performed and/or proposed. For example, an action may be block the content 603 from being incorporated into a project (e.g., block code from being used), block the content 603 from being shared, delete the content 603, report usage of the content 603, providing a notification of any license, updating an indication of usage (e.g., that the output is being used in a particular manner), etc.

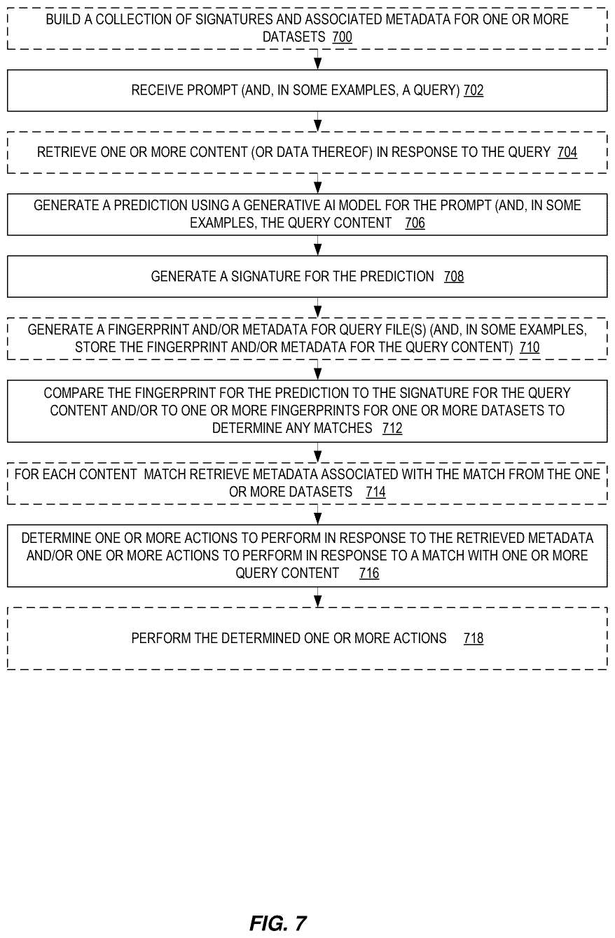

FIG. 7 is a flow diagram illustrating operations of a method for at least source tracing for GenAI output according to some examples. Some or all of the operations (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations are performed by at least the source tracing service 150 of the other figures.

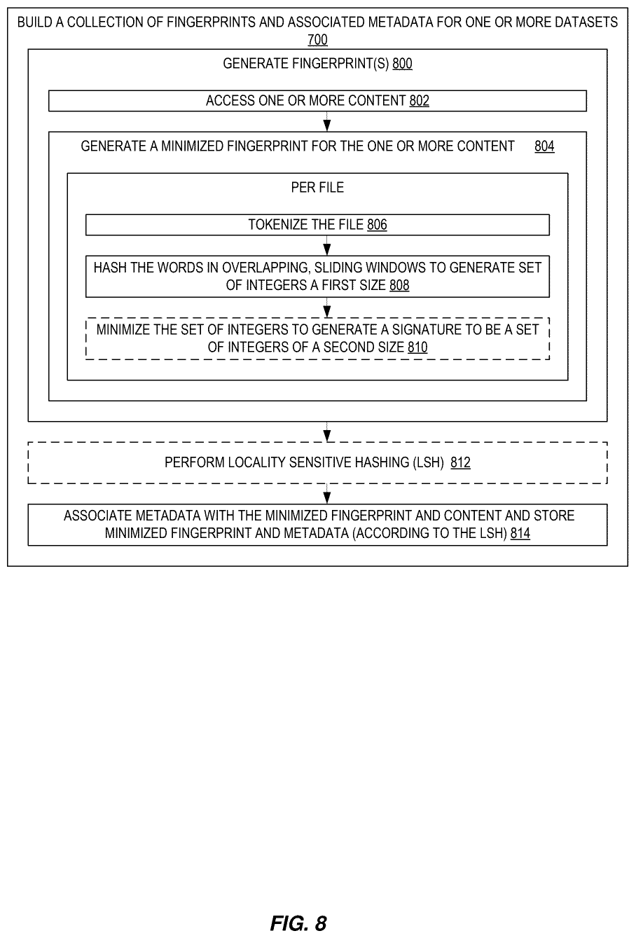

In some examples, a collection of fingerprints and associated metadata for one or more datasets is built at 700. FIG. 8 describes examples of a method for building such a collection. In some examples, the collection is stored using a storage service such as storage service 112.

A GenAI prompt is received at 702. In some examples, the GenAI model is hosted by the cloud provider network 100 such as hosted by a model hosting system 140. In some examples, the GenAI model is a part of a NLP service, content delivery service, etc. In some examples, a query (e.g., a RAG query) is received with the GenAI prompt. Note that a prompt may be text, visual, or audio. When the prompt is visual or audio, it is first transformed into text.

When the GenAI prompt is accompanied by a query, one or more content (or data thereof) is retrieved in response to the query at 704. Examples of this sort of querying have been detailed above.

The GenAI model is used to generate a prediction for the prompt (and, in some examples, using the query content) at 706. A fingerprint for the prediction is made at 708.

In some examples, a fingerprint and/or metadata for query content are generated at 710. In some examples, the fingerprint and/or metadata for the query content are stored. Note that the order of the description of actions may be moved around or actions done in parallel. For example, the fingerprint for query content could be generated while the GenAI model is making its prediction.

The fingerprint for the prediction is compared to the fingerprint for the query content and/or to one or more stored fingerprints for one or more datasets to determine any matches at 712. In some examples, the fingerprint of the prediction is compared to the fingerprint of the query content to determine if the query content was used in the generation of the prediction. In some examples, the fingerprint of the prediction is compared to stored fingerprints for training data to determine if the prediction aligns with data of the training data.

For each content fingerprint match, metadata associated with the match from the one or more datasets is retrieved at 714. Note that this should not be necessary if comparison is between the prediction and the query content.

One or more actions to perform or suggest in response to the retrieved metadata and/or one or more actions to perform or suggest in response to a match with one or more query content are determined at 716. Examples of such actions have been detailed above. In some examples, a match is determined based on how closely a signature matches (e.g., if the match is 95%.

In some examples, the one or more actions are performed at 718.

FIG. 8 is a flow diagram illustrating operations of a method for building a collection of fingerprints and associated metadata according to some examples. Some or all of the operations (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations are performed by source tracing service 150 of the other figures.

At 800 one or more fingerprint(s) are generated. This generation may involve a plurality of acts and may be performed by the fingerprint generator 227. In some examples, one or more content are accessed at 802. For example, one or more training datasets, a query result, content on a client device, etc.

For each of the one or more content, a minimized fingerprint is generated at 804. In some examples, the content is word tokenized at 806. The word tokenization removes stop words, performs lemmatization, stems words, and/or drops words less than a particular number of characters (such as 5 characters), etc.

The tokens are hashed to generate a set of integers at 808. In some examples, the hashing is performed on overlapping, sliding windows. In some examples, the windows are non-overlapping.

The set of integers is minimized by applying a hash (e.g., minhash or simhash) to generate a fingerprint at 810. In some examples, locality-sensitive hashing (LSH) is performed during after the hashing to weed out candidate pairs at 812.

Metadata is associated with the minimized fingerprint and content and the minimized fingerprint and metadata are stored at 814. In some examples, the storage is according to the LSH.

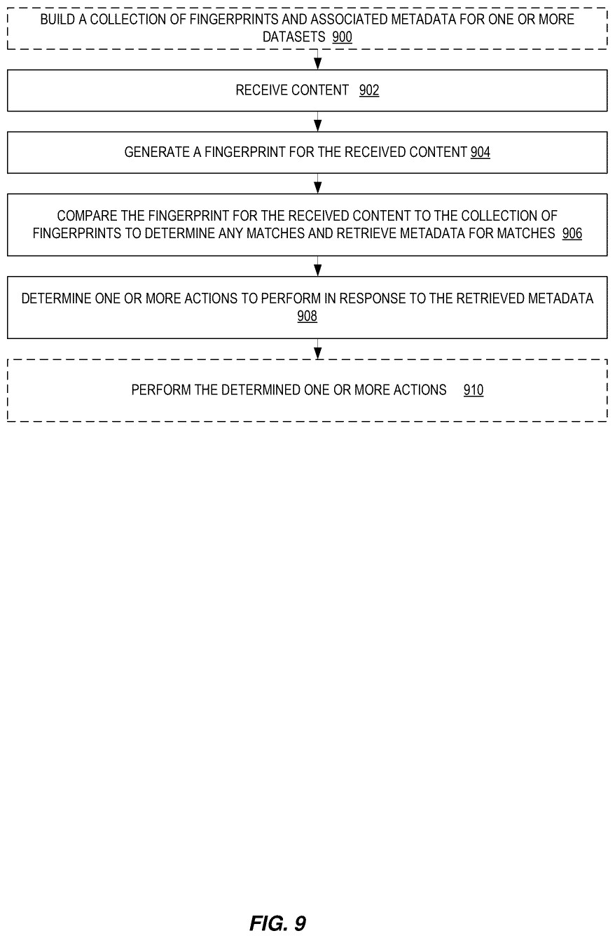

FIG. 9 is a flow diagram illustrating operations of a method for at least source tracing for content according to some examples. Some or all of the operations (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations are performed by source tracing component 550 and/or source tracing service 150 of the other figures.

In some examples, a collection of fingerprints and associated metadata for one or more datasets at 900. Examples of how collections may be built have been described earlier.

Content is received at 902. For example, a client device accesses content that is cloud stored, or receives contentvia a chat, email, etc., or downloads contentfrom a webpage, etc. In some examples, the contentis GenAI generated content (e.g., GenAI generated code). In some examples, the contentwas a rest (e.g., a part of committed code) and is received by the service to trace where it came from, etc.

A fingerprint for the received content is generated at 904. Fingerprint generation has been detailed above.

The fingerprint for the received contentis compared to the collection of fingerprints to determine any matches at 906 and associated metadata retrieved for a match.

One or more actions to perform or suggest in response to the retrieved metadata are determined at 908. Examples of such actions have been detailed above.

The action(s) are performed, in some examples, at 910.

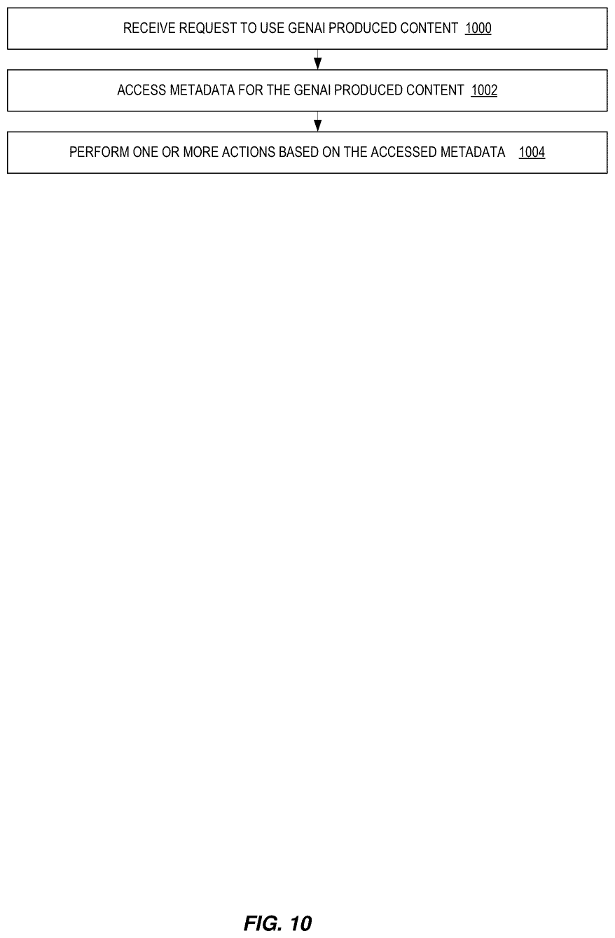

FIG. 10 is a flow diagram illustrating operations of a method for at least source tracing for content according to some examples. Some or all of the operations (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations are performed by source tracing component 550 and/or source tracing service 150 of the other figures.

A request to use GenAI produced content is received at 1000. For example, a user may request access to a particular code, etc.

Metadata for the GenAI produced content is accessed at 1002. In some examples, a fingerprint is first determined, and the metadata accessed based on that fingerprint anor/or model output. In some examples, the location of the content is used to access the metadata (e.g., by searching the fields of stored metadata.

One or more actions based on the accessed metadata at 1004. For example, an action may be to block the output from being incorporated into a project (e.g., block code from being used). This block may be based, at least in part, on the license associated with the matching content used during training. Other actions may include, but are not limited to: providing a notification of any license, updating an indication of usage (e.g., that the output is being used in a particular manner), etc.

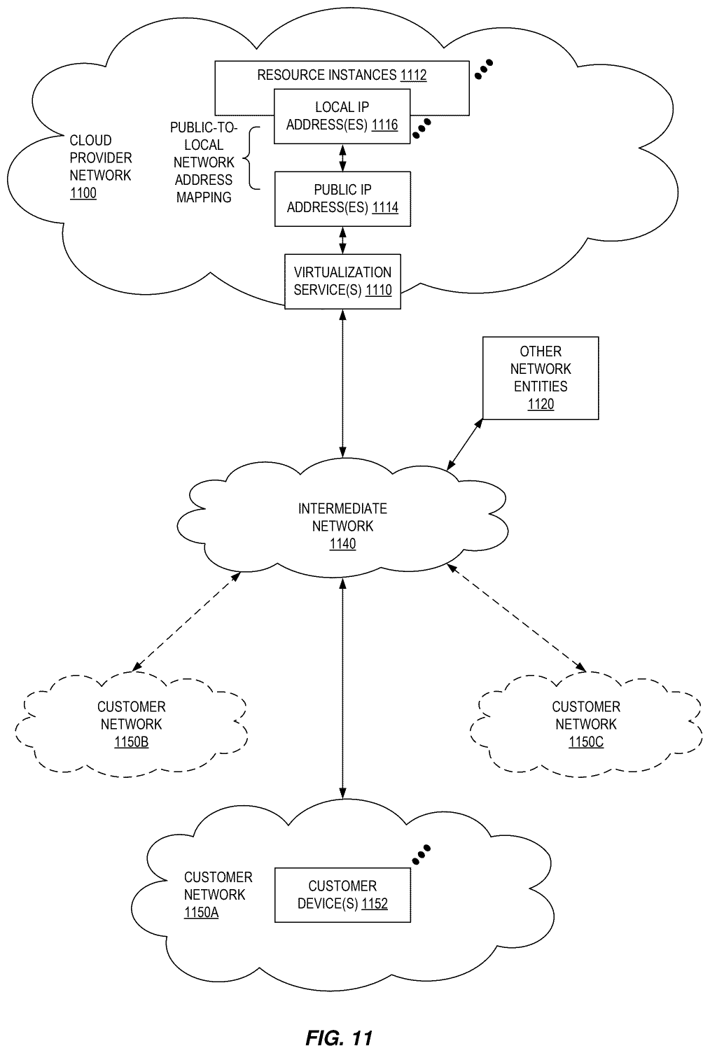

FIG. 11 illustrates an example provider network (or “service provider system”) environment according to some examples. A provider network 1100 can provide resource virtualization to customers via one or more virtualization services 1110 that allow customers to purchase, rent, or otherwise obtain instances 1112 of virtualized resources, including but not limited to computation and storage resources, implemented on devices within the provider network or networks in one or more data centers. Local Internet Protocol (IP) addresses 1116 can be associated with the resource instances 1112; the local IP addresses are the internal network addresses of the resource instances 1112 on the provider network 1100. In some examples, the provider network 1100 can also provide public IP addresses 1114 and/or public IP address ranges (e.g., Internet Protocol version 4 (IPv4) or Internet Protocol version 6 (IPv6) addresses) that customers can obtain from the provider 1100.

Conventionally, the provider network 1100, via the virtualization services 1110, can allow a customer of the service provider (e.g., a customer that operates one or more customer networks 1150A-1150C (or “client networks”) including one or more customer device(s) 1152) to dynamically associate at least some public IP addresses 1114 as fingerprinted or allocated to the customer with particular resource instances 1112 as fingerprinted to the customer. The provider network 1100 can also allow the customer to remap a public IP address 1114, previously mapped to one virtualized computing resource instance 1112 allocated to the customer, to another virtualized computing resource instance 1112 that is also allocated to the customer. Using the virtualized computing resource instances 1112 and public IP addresses 1114 provided by the service provider, a customer of the service provider such as the operator of the customer network(s) 1150A-1150C can, for example, implement customer-specific applications and present the customer's applications on an intermediate network 1140, such as the Internet. Other network entities 1120 on the intermediate network 1140 can then generate traffic to a destination public IP address 1114 published by the customer network(s) 1150A-1150C; the traffic is routed to the service provider data center, and at the data center is routed, via a network substrate, to the local IP address 1116 of the virtualized computing resource instance 1112 currently mapped to the destination public IP address 1114. Similarly, response traffic from the virtualized computing resource instance 1112 can be routed via the network substrate back onto the intermediate network 1140 to the source entity 1120.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193 and can be mutable within the provider network. Network traffic originating outside the provider network is not directly routed to local IP addresses; instead, the traffic uses public IP addresses that are mapped to the local IP addresses of the resource instances. The provider network can include networking devices or appliances that provide network address translation (NAT) or similar functionality to perform the mapping from public IP addresses to local IP addresses and vice versa.

Public IP addresses are Internet mutable network addresses that are asfingerprinted to resource instances, either by the service provider or by the customer. Traffic routed to a public IP address is translated, for example via 1:1 NAT, and forwarded to the respective local IP address of a resource instance.

Some public IP addresses can be asfingerprinted by the provider network infrastructure to particular resource instances; these public IP addresses can be referred to as standard public IP addresses, or simply standard IP addresses. In some examples, the mapping of a standard IP address to a local IP address of a resource instance is the default launch configuration for all resource instance types.

At least some public IP addresses can be allocated to or obtained by customers of the provider network 1100; a customer can then assign their allocated public IP addresses to particular resource instances allocated to the customer. These public IP addresses can be referred to as customer public IP addresses, or simply customer IP addresses. Instead of being asfingerprinted by the provider network 1100 to resource instances as in the case of standard IP addresses, customer IP addresses can be asfingerprinted to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer's account, not a particular resource instance, and the customer controls that IP address until the customer chooses to release it. Unlike conventional static IP addresses, customer IP addresses allow the customer to mask resource instance or availability zone failures by remapping the customer's public IP addresses to any resource instance associated with the customer's account. The customer IP addresses, for example, enable a customer to engineer around problems with the customer's resource instances or software by remapping customer IP addresses to replacement resource instances.

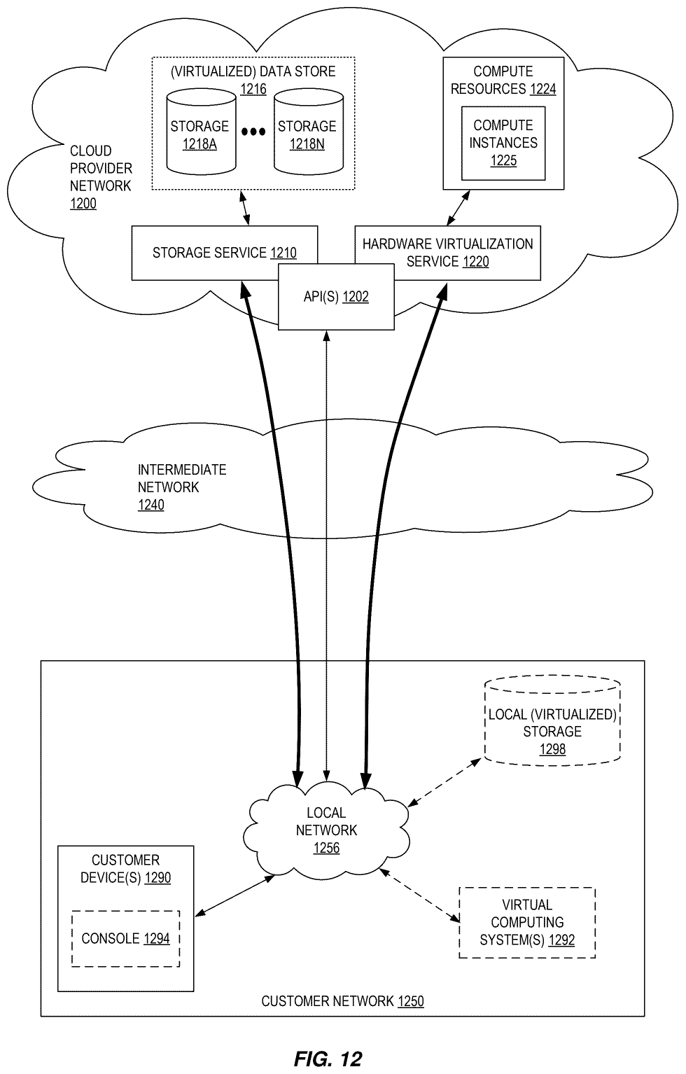

FIG. 12 is a block diagram of an example provider network environment that provides a storage service and a hardware virtualization service to customers, according to some examples. A hardware virtualization service 1220 provides multiple compute resources 1224 (e.g., compute instances 1225, such as VMs) to customers. The compute resources 1224 can, for example, be provided as a service to customers of a provider network 1200 (e.g., to a customer that implements a customer network 1250). Each computation resource 1224 can be provided with one or more local IP addresses. The provider network 1200 can be configured to route packets from the local IP addresses of the compute resources 1224 to public Internet destinations, and from public Internet sources to the local IP addresses of the compute resources 1224.

The provider network 1200 can provide the customer network 1250, for example coupled to an intermediate network 1240 via a local network 1256, the ability to implement virtual computing systems 1292 via the hardware virtualization service 1220 coupled to the intermediate network 1240 and to the provider network 1200. In some examples, the hardware virtualization service 1220 can provide one or more APIs 1202, for example a web services interface, via which the customer network 1250 can access functionality provided by the hardware virtualization service 1220, for example via a console 1294 (e.g., a web-based application, standalone application, mobile application, etc.) of a customer device 1290. In some examples, at the provider network 1200, each virtual computing system 1292 at the customer network 1250 can correspond to a computation resource 1224 that is leased, rented, or otherwise provided to the customer network 1250.

From an instance of the virtual computing system(s) 1292 and/or another customer device 1290 (e.g., via console 1294), the customer can access the functionality of a storage service 1210, for example via the one or more APIs 1202, to access data from and store data to storage resources 1218A-1218N of a virtual data store 1216 (e.g., a folder or “bucket,” a virtualized volume, a database, etc.) provided by the provider network 1200. In some examples, a virtualized data store gateway (not shown) can be provided at the customer network 1250 that can locally cache at least some data, for example frequently accessed or critical data, and that can communicate with the storage service 1210 via one or more communications channels to upload new or modified data from a local cache so that the primary store of data (the virtualized data store 1216) is maintained. In some examples, a user, via the virtual computing system 1292 and/or another customer device 1290, can mount and access virtual data store 1216 volumes via the storage service 1210 acting as a storage virtualization service, and these volumes can appear to the user as local (virtualized) storage 1298.

While not shown in FIG. 12, the virtualization service(s) can also be accessed from resource instances within the provider network 1200 via the API(s) 1202. For example, a customer, appliance service provider, or other entity can access a virtualization service from within a respective virtual network on the provider network 1200 via the API(s) 1202 to request allocation of one or more resource instances within the virtual network or within another virtual network.

### Illustrative Systems

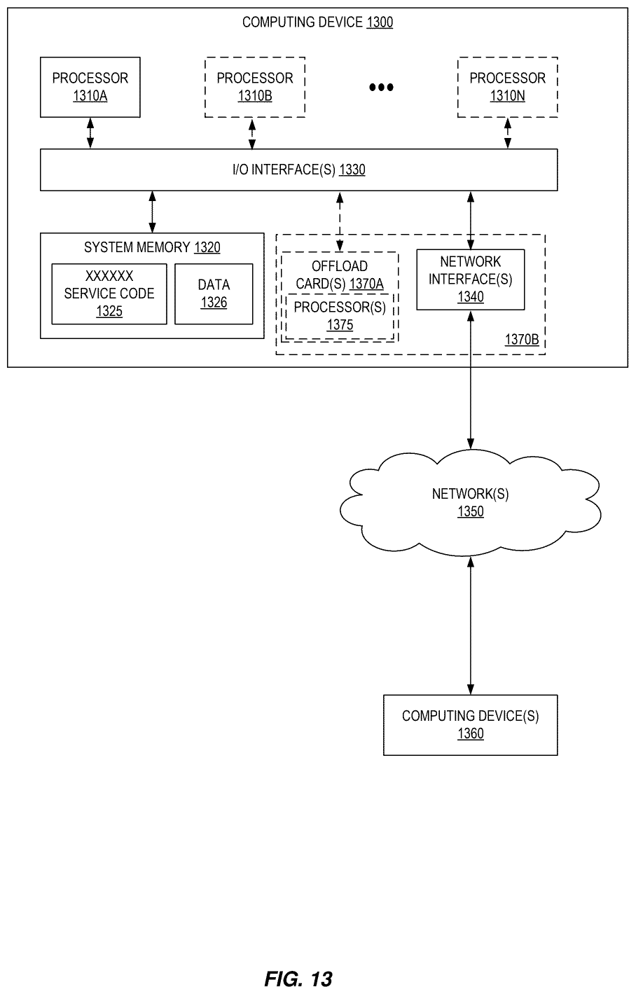

In some examples, a system that implements a portion or all of the techniques described herein can include a general-purpose computer system, such as the computing device 1300 (also referred to as a computing system or electronic device) illustrated in FIG. 13, that includes, or is configured to access, one or more computer-accessible media. In the illustrated example, the computing device 1300 includes one or more processors 1310 coupled to a system memory 1320 via an input/output (I/O) interface 1330. The computing device 1300 further includes a network interface 1340 coupled to the I/O interface 1330. While FIG. 13 shows the computing device 1300 as a single computing device, in various examples the computing device 1300 can include one computing device or any number of computing devices configured to work together as a single computing device 1300.

In various examples, the computing device 1300 can be a uniprocessor system including one processor 1310, or a multiprocessor system including several processors 1310 (e.g., two, four, eight, or another suitable number). The processor(s) 1310 can be any suitable processor(s) capable of executing instructions. For example, in various examples, the processor(s) 1310 can be general-purpose or embedded processors implementing any of a variety of instruction set architectures (ISAs), such as the x86, ARM, PowerPC, SPARC, or MIPS ISAs, or any other suitable ISA. In multiprocessor systems, each of the processors 1310 can commonly, but not necessarily, implement the same ISA.

The system memory 1320 can store instructions and data accessible by the processor(s) 1310. In various examples, the system memory 1320 can be implemented using any suitable memory technology, such as random-access memory (RAM), static RAM (SRAM), synchronous dynamic RAM (SDRAM), nonvolatile/Flash-type memory, or any other type of memory. In the illustrated example, program instructions and data implementing one or more desired functions, such as those methods, techniques, and data described above, are shown stored within the system memory 1320 as source tracing service code 1325 (e.g., executable to implement, in whole or in part, the source tracing service 150) and data 1326.

In some examples, the I/O interface 1330 can be configured to coordinate I/O traffic between the processor 1310, the system memory 1320, and any peripheral devices in the device, including the network interface 1340 and/or other peripheral interfaces (not shown). In some examples, the I/O interface 1330 can perform any necessary protocol, timing, or other data transformations to convert data signals from one component (e.g., the system memory 1320) into a format suitable for use by another component (e.g., the processor 1310). In some examples, the I/O interface 1330 can include support for devices attached through various types of peripheral buses, such as a variant of the Peripheral Component Interconnect (PCI) bus standard or the Universal Serial Bus (USB) standard, for example. In some examples, the function of the I/O interface 1330 can be split into two or more separate components, such as a north bridge and a south bridge, for example. Also, in some examples, some or all of the functionality of the I/O interface 1330, such as an interface to the system memory 1320, can be incorporated directly into the processor 1310.

The network interface 1340 can be configured to allow data to be exchanged between the computing device 1300 and other computing devices 1360 attached to a network or networks 1350, such as other computer systems or devices as illustrated in FIG. 1, for example. In various examples, the network interface 1340 can support communication via any suitable wired or wireless general data networks, such as types of Ethernet network, for example. Additionally, the network interface 1340 can support communication via telecommunications/telephony networks, such as analog voice networks or digital fiber communications networks, via storage area networks (SANs), such as Fibre Channel SANs, and/or via any other suitable type of network and/or protocol.

In some examples, the computing device 1300 includes one or more offload cards 1370A or 1370B (including one or more processors 1375, and possibly including the one or more network interfaces 1340) that are connected using the I/O interface 1330 (e.g., a bus implementing a version of the Peripheral Component Interconnect-Express (PCI-E) standard, or another interconnect such as a QuickPath interconnect (QPI) or UltraPath interconnect (UPI)). For example, in some examples the computing device 1300 can act as a host electronic device (e.g., operating as part of a hardware virtualization service) that hosts compute resources such as compute instances, and the one or more offload cards 1370A or 1370B execute a virtualization manager that can manage compute instances that execute on the host electronic device. As an example, in some examples the offload card(s) 1370A or 1370B can perform compute instance management operations, such as pausing and/or un-pausing compute instances, launching and/or terminating compute instances, performing memory transfer/copying operations, etc. These management operations can, in some examples, be performed by the offload card(s) 1370A or 1370B in coordination with a hypervisor (e.g., upon a request from a hypervisor) that is executed by the other processors 1310A-1310N of the computing device 1300. However, in some examples the virtualization manager implemented by the offload card(s) 1370A or 1370B can accommodate requests from other entities (e.g., from compute instances themselves), and cannot coordinate with (or service) any separate hypervisor.

In some examples, the system memory 1320 can be one example of a computer-accessible medium configured to store program instructions and data as described above. However, in other examples, program instructions and/or data can be received, sent, or stored upon different types of computer-accessible media. Generally, a computer-accessible medium can include any non-transitory storage media or memory media such as magnetic or optical media, e.g., disk or DVD/CD coupled to the computing device 1300 via the I/O interface 1330. A non-transitory computer-accessible storage medium can also include any volatile or non-volatile media such as RAM (e.g., SDRAM, double data rate (DDR) SDRAM, SRAM, etc.), read only memory (ROM), etc., that can be included in some examples of the computing device 1300 as the system memory 1320 or another type of memory. Further, a computer-accessible medium can include transmission media or signals such as electrical, electromagnetic, or digital signals, conveyed via a communication medium such as a network and/or a wireless link, such as can be implemented via the network interface 1340.

Various examples discussed or suggested herein can be implemented in a wide variety of operating environments, which in some cases can include one or more user computers, computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and/or other devices capable of communicating via a network.

Most examples use at least one network that would be familiar to those skilled in the art for supporting communications using any of a variety of widely available protocols, such as Transmission Control Protocol/Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In examples using a web server, the web server can run any of a variety of server or mid-tier applications, including HTTP servers, File Transfer Protocol (FTP) servers, Common Gateway Interface (CGI) servers, data servers, Java servers, business application servers, etc. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python, PHP, or TCL, as well as combinations thereof. The server(s) can also include database servers, including without limitation those commercially available from Oracle®, Microsoft®, Sybase®, IBM®, etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of examples, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate examples can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc-Read Only Memory (CD-ROM), Digital Versatile Disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various examples.

In the preceding description, various examples are described. For purposes of explanation, specific configurations and details are set forth to provide a thorough understanding of the examples. However, it will also be apparent to one skilled in the art that the examples can be practiced without the specific details. Furthermore, well-known features can be omitted or simplified in order not to obscure the example being described.

Bracketed text and blocks with dashed borders (e.g., large dashes, small dashes, dot-dash, and dots) are used herein to illustrate optional aspects that add additional features to some examples. However, such notation should not be taken to mean that these are the only options or optional operations, and/or that blocks with solid borders are not optional in certain examples.

Reference numerals with suffix letters (e.g., 1218A-1218N) can be used to indicate that there can be one or multiple instances of the referenced entity in various examples, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C, where the second processor could be part of same computing device as the first processor or part of a separate computing device as the first processor.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A computer-implemented method comprising:
receiving a prompt to generate code using a generative artificial intelligence (GenAI) model;
generating the code using the GenAI model;
generating a fingerprint for the code;
comparing the fingerprint for the code to one or more fingerprints for code of one or more datasets to determine a match, wherein the one or more datasets have been used to train the GenAI model;
retrieving metadata associated with the match, wherein the metadata at least includes an indication of any open source license associated with the matching code; and
determining and performing one or more actions in response to the retrieved metadata.

2. The computer-implemented method of claim 1, wherein a query for augmented data is provided with the prompt to generate code using a generative artificial intelligence (GenAI) model, wherein the method further comprises:
retrieving one or more files in response to the query; and
providing the retrieved one or more files with the prompt to the GenAI model.

3. The computer-implemented method of claim 1, wherein the metadata includes one or more of a link to a file, a classification, an indication of a license associated with the file, an indication of usage of generated content, an indication of a hash used to generate the fingerprint, and an indication of a model used to produce the content.

4. A computer-implemented method comprising:
receiving a prompt to generate content using a generative artificial intelligence (GenAI) model;
generating the content using the GenAI model;
generating a fingerprint for the content;
comparing the fingerprint for the content to one or more fingerprints for content of one or more datasets to determine a match;
retrieving metadata associated with the match; and
determining and performing one or more actions in response to the retrieved metadata.

5. The computer-implemented method of claim 4, wherein the content is code.

6. The computer-implemented method of claim 5, wherein the one or more datasets includes of one or more code repositories.

7. The computer-implemented method of claim 6, wherein the of one or more code repositories are subject to one or more open source licenses.

8. The computer-implemented method of claim 5, wherein the one or more actions are depending on an open source license of the one or more open source licenses.

9. The computer-implemented method of claim 4, wherein a query for augmented data is provided with the prompt to generate content using a generative artificial intelligence (GenAI) model, wherein the method further comprises:
retrieving one or more files in response to the query; and
providing the retrieved one or more files with the prompt to the GenAI model.

10. The computer-implemented method of claim 9, further comprising:
generating a fingerprint for the retrieved one or more files;
associating metadata with the generated a fingerprint for the retrieved one or more files; and
storing the generated fingerprint for the retrieved one or more files and the associated metadata.

11. The computer-implemented method of claim 4, wherein the metadata includes one or more of a link to a file, a classification, an indication of a license associated with the file, an indication of usage of generated content, an indication of a hash used to generate the fingerprint, and an indication of a model used to produce the content.

12. The computer-implemented method of claim 4, further comprising:
building a collection of fingerprints and associated metadata for one or more datasets.

13. The computer-implemented method of claim 4, wherein generating a fingerprint for the content comprises:
word tokenizing the content;
performing a first hashing of the tokenized words to generate a set of values; and
minimizing the generated set of values.

14. The computer-implemented method of claim 4, wherein comparing the fingerprint for the content to one or more fingerprints for content of one or more datasets to determine a match, wherein the one or more datasets have been used to train the GenAI model comprises accessing one or more storage locations that store fingerprints according to a locality sensitive hash.

15. The computer-implemented method of claim 4, wherein one or more datasets have been used to influence the GenAI model.

16. A system comprising:
a first one or more computing devices to implement a storage service in a multi-tenant provider network; and
a second one or more computing devices to implement a source tracing service in the multi-tenant provider network, the source tracing service including instructions that upon execution cause the source tracing service to:
receive a prompt to generate content using a generative artificial intelligence (GenAI) model;
generate the content using the GenAI model;
generate a fingerprint for the content;
compare the fingerprint for the content to one or more fingerprints, to be stored by the storage service, for content of one or more datasets to determine a match;
retrieve metadata associated with the match; and
determine and performing one or more actions in response to the retrieved metadata.

17. The system of claim 16, further comprising:
a model hosting service to host the GenAI model.

18. The system of claim 16, further comprising:
a code generation service to implement the GenAI model to generate code.

19. The system of claim 16, wherein the content is subject to one or more licenses.

20. The system of claim 16, wherein to generate a fingerprint for the content comprises to:
word tokenize the content;
perform a first hashing of the tokenized words to generate a set of values; and
minimize the generated set of values.
